(19) United States
(12) Patent Application Publication
(10) Pub. No.: US 2013/0006818 A1
(43) Pub. Date: Jan. 3, 2013

(54) SYSTEM AND METHOD FOR OPTIMIZING SAVINGS RELATIVE TO PURCHASING PRODUCTS

(75) Inventors: Marianne Hall, Aurora, IL (US); Randy Hall, Aurora, IL (US)

(73) Assignee: SHOPPER'S HAUL, LLC., Aurora, IL (US)

(21) Appl. No.: 13/535,449

(22) Filed: Jun. 28, 2012

Related U.S. Application Data
(60) Provisional application No. 61/502,310, filed on Jun. 28, 2011.

(51) Int. Cl. G06Q 30/06

(52) U.S. Cl. 705/27.1

(57) ABSTRACT

A system and method is provided for optimizing a purchase of a desired product on a computer. The method includes receiving product information related to the desired product, a companion product, shelf prices, ring prices, a price threshold, and a rebate amount, and calculating a total shelf price based on shelf prices of the desired and companion products. The method further includes determining whether the total shelf price is greater than or equal to the price threshold, and if so, calculating a total ring price based on the ring prices of the desired and companion products. A result set is provided with the total shelf price and the total ring price. The result set may be ordered based on the total ring price. If a selection of a desired product is received, the result set may include the desired product.

### CROSS-REFERENCE TO RELATED APPLICATION

This application claims priority to U.S. Provisional Patent Application No. 61/502,310, filed Jun. 28, 2011, entitled “System and Method for Optimizing Savings Relative to Purchasing Products”, and is incorporated herein by reference in its entirety.

### TECHNICAL FIELD

This invention relates generally to systems and methods for managing purchases of products in a retail environment. More particularly, the present invention relates to a system, method, and apparatus for optimizing a purchase of a desired product and a companion product or products based on shelf prices and ring prices of the desired product and the companion product(s), a price threshold, and a rebate amount.

### BACKGROUND OF THE INVENTION

This invention relates generally to purchasing of products in a retail environment. Prior product purchasing application apparatuses and systems have been attempted and implemented. For example, software applications and websites exist which accept product information and display prices for the products at physical and online retail stores for comparison purposes, such as using spreadsheets or other software. Other software applications and websites enable the purchase of a product for delivery or pickup at a physical location. Even other applications allow users to manually enter the order in which such users intend on purchasing products prior to arriving at a store, so that the task of purchasing the products can be planned and remembered.

However, the prior systems and methods are unable to optimize the purchase of a desired product and companion product or products in order to take advantage of sales, coupons, and rebates that are offered by retailers. In particular, consumers are in need of more efficient and time-saving ways to assist in determining the purchase of products to maximize monetary savings.

### SUMMARY OF THE INVENTION

The present invention is defined by the appended claims. This description summarizes some aspects of the present embodiments and should not be used to limit the claims.

The foregoing problems are solved and a technical advance is achieved by a system, method, and articles of manufacture consistent with the present invention, which optimize a purchase of a desired product.

The present invention permits optimization of a purchase of a desired product using a computer. The optimization may be provided to a user of the computer to assist in purchasing the desired product and one or more companion products. By optimizing the purchase of the desired product, the present invention assists in maximizing the time and money expended by the user in planning shopping excursions. In one aspect of the present invention, product information is received by the computer, including information about the desired product, the companion product, shelf prices of the desired product and the companion product, ring prices of the desired product and the companion product, a price threshold, and a rebate amount. In another aspect of the present invention, a selection of the desired product is received, followed by a calculation of a total shelf price based on the shelf prices of the desired product and the companion product. In another aspect of the present invention, if the total shelf price is greater than or equal to the price threshold, a total ring price is calculated as well as a difference between the total ring price and the rebate amount. The total ring price and the difference are calculated based on the ring prices of the desired product and the companion product, and the rebate amount. In a further aspect of the present invention, a result set is transmitted including the total shelf price and the total ring price.

Other systems, methods, articles of manufacture, features, and advantages of the present invention will be, or will become, apparent to one having ordinary skill in the art upon examination of the following drawings and detailed description. It is intended that all such additional systems, methods, articles of manufacture, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a system diagram illustrating an embodiment of a computer networked system in accordance with the invention.

FIG. 2 is a schematic diagram of one computer implemented embodiment of the present invention.

FIG. 3 is a schematic diagram of a memory portion of the computer implemented embodiment of FIG. 2.

FIG. 4 is a flow chart illustrating one embodiment of a process for optimizing a purchase of a desired product and a companion product in accordance with the present invention.

FIG. 5 is a flow chart illustrating an embodiment of a process for determining the optimization of the purchase of the desired product in accordance with the invention.

FIGS. 6A and 6B are exemplary screenshots of a mobile application interface for entering optimization data.

FIGS. 7A and 7B are exemplary screenshots of a mobile application interface for transmitting a result set.

FIG. 8 is an exemplary screenshot of a mobile application interface for selecting a desired product within the result set.

FIG. 9 is an exemplary screenshot of a mobile application interface for generating analysis reports.

FIG. 10 is an exemplary screenshot of a mobile application interface for an analysis report related to money saved through use of the invention.

FIG. 11 is an exemplary screenshot of a mobile application interface for an analysis report related to product purchase history.

Illustrative and exemplary embodiments of the invention are described in further detail below with reference to and in conjunction with the figures.

### DETAILED DESCRIPTION OF THE INVENTION

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

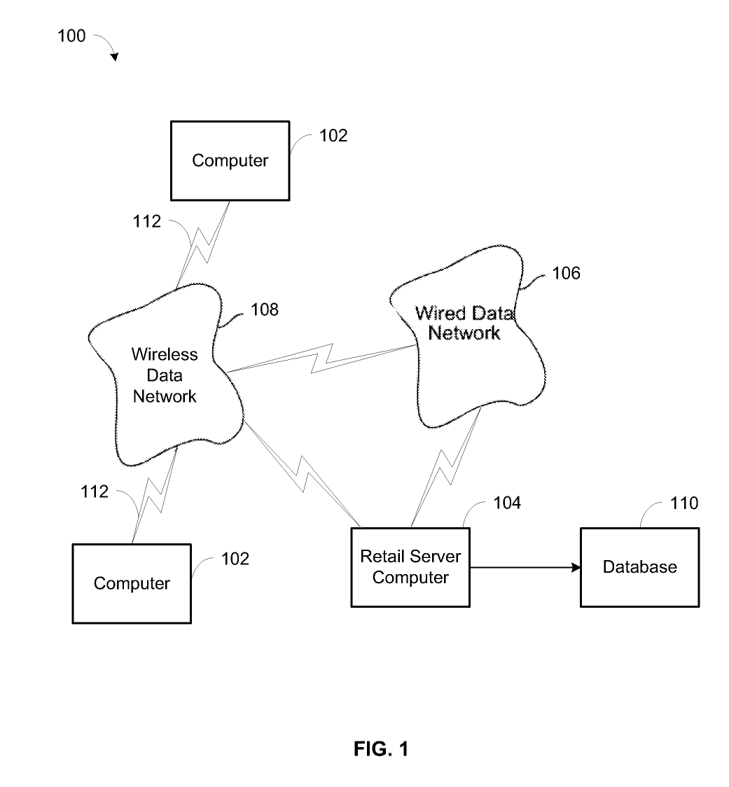

Referring to FIG. 1, a system diagram illustrates an embodiment of a computer networked system 100 for optimizing a purchase of a desired product on a computer, such as a wireless mobile personal computer. In one embodiment, the computer networked system 100 includes a plurality of computers 102, a retail server computer 104, a wired data network 106, and a wireless data network 108. The wired data network 106 can be a global network, a wide area network, or a local area network. The wireless data network 108, which can couple to the wired data network 106, can include one of more wireless data networks, such as cellular networks, WiFi networks, Bluetooth networks, etc. The retail server computer 104 can couple to both the wired data network 106 and the wireless data network 108. The computers 102 can couple to the wireless data network 108 over wireless links 112. In this regard, the computers 102 can access the retail server computer 104 through the wireless data network 108. The wired data network 106 and the wireless data network 108 pertain to some portions of the World Wide Web (WWW, hereafter referred to as Web) and the Internet.

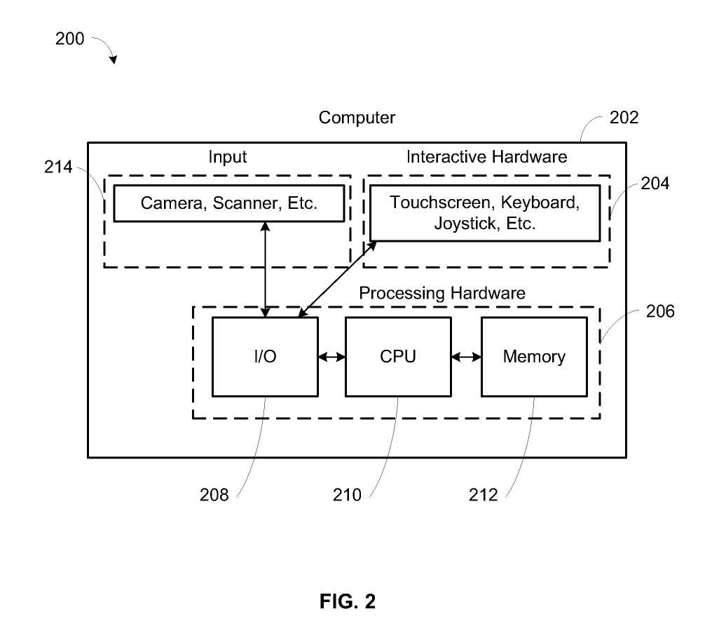

Now referring to FIG. 2, a diagram 200 illustrates schematically one of the computers 102 of FIG. 1. The illustrated computer 202 is preferably a handheld digital device of palm size or smaller, and can be a personal digital assistant (PDA), a cellular phone, a hybrid between a cellular phone and a PDA, a smart phone such as an iPhone (3G, 3GS, 4, 4S, or other versions), or any other handheld electronic device having a display screen. The computer 202 includes an interactive hardware portion 204, a processing hardware portion 206, and an input portion 214. The interactive hardware portion 204 can include one or more of a touch screen, a keyboard, a stylus, a joystick, and the like, which can be arranged in various manners and have different shapes without changing the spirit of the interaction of the hardware portion 204 with the I/O portion 208. The touch screen can be a liquid crystal display (LCD), display screen, a plasma screen, a light emitting diode (LED), or any other screen capable of displaying text and images. The input portion 214 can include one or more of a camera, a barcode scanner, a laser reader, and the like, which can be arranged in various manners and have different shapes without changing the spirit of the interaction of the input portion 214 with the I/O portion 208.

The processing hardware portion 206 includes an input/output (I/O) portion 208, a central processing unit (CPU) portion 210, i.e., a microprocessor, and a memory 212. The CPU portion 210 can be any computer-processing unit from a singular microchip to extensive microchip configurations. The memory portion 212 can include, without limitation, any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory portion 212 may incorporate electronic, magnetic, optical, and/or other types of storage media, and can have a distributed architecture where various components are situated remotely from one another, but are still accessed by the microprocessor portion 210. The interactive hardware portion 204 and the input portion 214 are coupled to the I/O portion 208 such that a command, scanned image, picture, or other input entered or provided by a user through the interactive hardware portion 204 or the input portion 214 will be forwarded to the I/O portion 208, to the processor portion 210, and then to memory portion 212.

The input portion 214 may be implemented as a barcode scanner, which can be any one of known conventional barcode readers or scanners, including sequential barcode scanners and charge-coupled device (“CCD”) barcode scanners. A sequential barcode scanner, for example, uses a scanning beam, typically narrow band light in the visible spectrum such as red laser, but potentially any bandwidth of light in the visible or infrared spectra, to pass over barcodes or optical machine-readable representations. The barcodes can be one-dimensional (1D) or two-dimensional barcodes. The 1D barcodes are typically represented by a sequence of dark bars or lines and spaces, and the 2D barcodes, also termed 2D (2 dimensional) matrix codes, are typically represented by patterns of squares, dots, hexagons and other geometric patterns. Another type of sequential scanner is a wand scanner, which is swept across the barcode by a user to create the scanning beam. As the scanning beam of light scans across the barcode, the beam is at least partially reflected back to the scanner by the spaces and is at least partially absorbed by the dark bars. A receiver, such as a photocell detector, in the scanner receives the reflected beam and converts the beam into an electrical signal. As the beam scans across the barcode, the scanner typically creates a low electrical signal for the spaces, i.e., reflected beam, and a high electrical signal for the bars, i.e., where the beam is absorbed. The scanner may, however, create a low electrical signal for the bars and a high electrical signal for the spaces. The width of the bars and spaces determines the duration of the electrical signal. This signal is decoded by the scanner or by an external processor into characters that the barcode represents. In a CCD scanner, however, the scanner takes a digital image of the barcode and decodes the barcode using software that is well known in the art to convert the elements into the identification code. In either a sequential barcode scanner or a CCD scanner, the contrast between the bars and spaces is used to distinguish the elements and decode the barcode. A barcode displayed on an LCD screen such as on a PDA or cell phone, for example, has a contrast between the gray “off” state designating a space of the barcode and the black “on” state designating a bar than is available for a barcode printed on a black and white label.

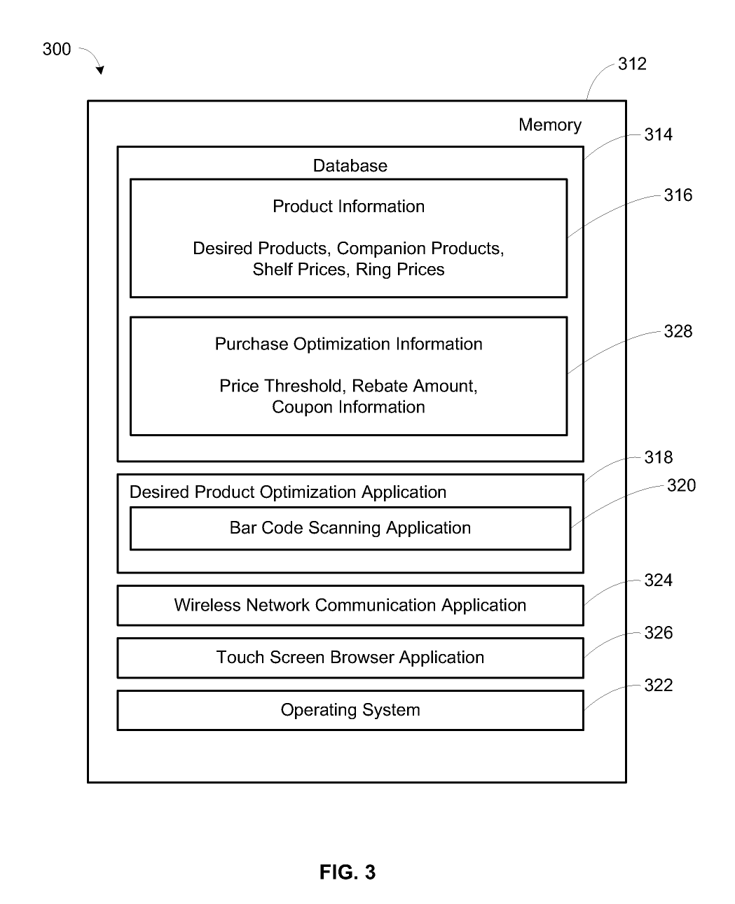

As illustrated in FIG. 3, a schematic diagram 300 of the memory portion 212 of FIG. 2 is shown. The memory portion 312 can include or store a database 314, executable programs 318, 324, and 326, and an operating system 322. The database 314 can store product information 316, which can include the names and other characteristics of retail products, shelf prices of the products, and ring prices of the products. The name of a product can include its brand name, category, manufacturer name, size, weight, color, flavor, scent, Universal Product Code (UPC) number, stock-keeping unit (SKU) number, price lookup (PLU) number, and any other information to assist a user in identifying the product. Products in the database 314 may include desired products and companion products. A desired product is a product that a user wishes to purchase for personal or business use. In contrast, a companion product is a product that the user does not necessarily want to purchase for personal or business use. The user may purchase one or more companion products in order to take advantage of a sale or rebate associated with the companion product that will allow the user to purchase the desired product at a price lower than the shelf price or ring price of the desired product. The shelf price of a product can include the regular selling price of the product without any discount, i.e., the suggested retail price or list price when the product is not on sale. The ring price of a product can include the price that the product is actually sold for by the store, i.e., the price when any discounts are applied to the shelf price of the product. Applicable discounts may include discounts given by the store and/or a manufacturer involving the use of a preferred savings card, a discount card, a club savings card, or other types of discounting schemes.

The database 314 can also store purchase optimization information 328, which can include a price threshold, rebate amount, and coupon information. The purchase optimization information 328 may be manually entered by the user, obtained automatically, or via a combination of manual and automated data input. The price threshold in the database 314 can include a minimum amount that the user must purchase to qualify for a rebate, sale, or other discount. The price threshold may include a specific total shelf price of purchased products, a specific total ring price of purchased products, a specific quantity of purchased products, and/or other qualifying criteria. Products that are purchased to satisfy the price threshold may include desired and companion products in any combination. For example, a specific total shelf price of products may need to be purchase in order to qualify for the rebate, sale, or discount, e.g., buy $10 worth of particular products and receive a $5.00 off coupon on your next order. As another example, a specific quantity of products may need to be purchased (with or without regard to the prices of those products) in order to qualify for the rebate, sale, or discount, e.g., buy six particular products and receive a $5.00 instant discount.

The rebate amount in the database 314 can include an amount or percentage received by the user to discount the current purchase or a future purchase. For example, the rebate may be a Checkout Coupon by Catalina Marketing Corporation or a similar coupon or voucher that may be exchanged for a discount at a store. The rebate may also be electronically attached to a preferred savings card. The rebate may further be an instant rebate applicable to a current transaction or may be cash given back to the user. The rebate may include a specific amount or percentage discounted off of a total transaction, part of a transaction, or a particular product. Coupon information in the database 314 can include optional manufacturer or store coupons and their associated discount amounts. The coupon information may represent discounts applicable to a particular product or brand that can be obtained by redeeming a preprinted, computer-printed, or electronic coupon. Such coupons are publicly available from newspapers, magazines, coupon inserts, direct mailings, advertisements, Internet websites, and other sources.

The executable programs can include one or more desired product optimization computer software code segments or applications 318, a barcode scanning application 320, a wireless network communication software application 324, and a touch screen browser software application 326, each stored within the memory portion 312 or other computer hardware device, for operating in connection with the microprocessor portion 210 or other hardware device. For the sake of simplicity, the barcode scanning application 320 is considered to be a sub code segment or part of the desired product optimization application 318. The executable programs 318 can be implemented in software, firmware, hardware, or a combination thereof. An example of a suitable commercially available operating system 322 is an appliance-based operating system, such as that implemented in handheld computers or personal digital assistants (PDAs) (e.g., PalmOS available from Palm Computing, Inc., iPhone/iPod OS available from Apple, and Windows CE available from Microsoft Corporation). The operating system 322 essentially controls the execution of other computer programs, such as the desired product optimization application 318, and provides scheduling, input-output control, file and data management, memory management, and communication control and related services.

When the computer 102 is in operation, the CPU portion 210 is configured to execute software stored within the memory 212, 312, to communicate data to and from the memory 212, 312, and to generally control operations of the computer 102 pursuant to the software. The desired product optimization application 318, and the operating system 322, in whole or in part, but typically the latter, are read by the CPU portion 210, perhaps buffered within the CPU portion 210, and then executed. When the desired product optimization application 318 is implemented in software, it can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The desired product optimization application 318 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. In another embodiment, where the desired product optimization application 318 is implemented in hardware, it can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As discussed above, each one of the computers 102 can include a touch screen browser software application 326. In one embodiment, the touch screen browser application 326 is provided for displaying a plurality of product selection interface screens of the present invention and receiving user selections in response thereto. In the embodiment shown in FIG. 2, the CPU portion 210 at least in part generates, launches, communicates, and/or implements the product selection interface screens for allowing and causing the touch screen browser application to display the product selection interface screens on the interactive hardware portion 204, for simplicity hereafter referred to as a screen display. As shown in FIGS. 2 and 3, the CPU portion 210 can include in memory 312 a desired product optimization application 318 for launching, communicating, and/or implementing the product selection interface screens of the present invention.

The user can view the product selection interface screens as displayed on the screen display 204 by launching the desired product optimization application 318, and the user can utilize these product selection interface screens to select a desired product and to optimize the purchase of the desired product and the companion product(s). One or more desired products may be selected and purchased. Also, one or more desired and companion products, in any combination, may be purchased in order to optimize the purchase of the desired product. In one embodiment, the presentation on the screen display 204 is created and controlled by software, such as the desired product optimization application 318 and information received from the CPU portion 210.

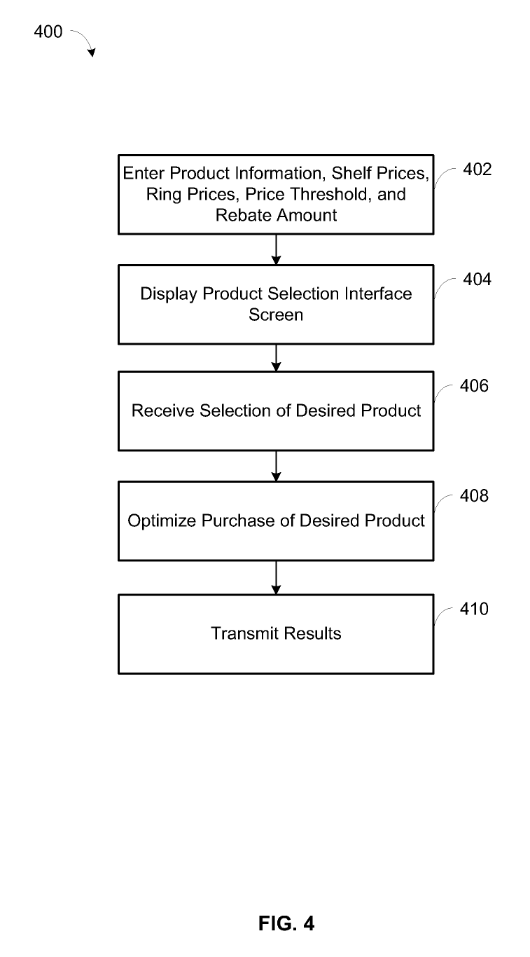

Referring to FIG. 4, flow chart 400 illustrates a process or method for optimizing a purchase of a desired product and one or more companion product(s). Results of the optimization process are transmitted or displayed, for example, on the screen display 204 during execution of the desired product optimization application 318. In one embodiment, the customer can download the application 318 or “App” directly from a third party, such as Apple iTunes or Google App Store, or such as from an App developer site. Alternatively, the desired product optimization application 318 can be in the form of a mobile website that can be launched from an icon on a mobile device that is merely a link to such a website. In either case, a link could be provided from a website in order to have the customer redirected to where the App/icon is located for downloading. As stated, the desired product optimization application 318 can be accessed on a website using the Internet and a computer running a web browser program. The computer may be the computer 102 or any other computer with access to the Internet.

The results from the desired product optimization application 318 may include desired and companion product information, quantities of the desired and companion products to be purchased, the total shelf price, the total ring price, and other information, all of which will be discussed in more detail below. The user may utilize the optimization results to purchase a combination of desired and companion products in one or more transactions to take advantage of a rebate that will allow the user to purchase the desired product at a price lower than the shelf price or ring price of the desired product. For example, the user may purchase a certain quantity of the companion product in order to exceed the price threshold and obtain a rebate to discount a future transaction. The rebate may then be redeemed by the user to reduce the out-of-pocket cost of the desired product in the future transaction. In some cases, the user may only need to purchase certain quantities of the desired product to obtain the applicable rebate and maximize their savings. The optimization results can preferably be displayed in order of lowest to highest total ring price such that the user is informed of the greatest value, i.e., the least amount the user has to spend out-of-pocket to obtain the desired product. The total ring price may include one or more quantities that are to be purchased of the desired and/or companion products. Alternatively, the optimization results may be ordered by other criteria to make best use of the results depending on the needs of the user, such as ordering by product name, category, shelf price, ring price, or other characteristics. The results may be ordered by the other criteria alone or in combination with the total ring price.

At step 402, desired and companion product information, shelf prices, ring prices, the price threshold, the rebate amount, and coupon information (hereafter collectively referred to as optimization data) are entered. The optimization data and/or the coupon information may include the value of the coupon (e.g., $0.50 off, $1.00 off, 25% off, etc.) and/or an exact quantity of products that need to be purchased in order to satisfy the terms of the coupon (e.g., $2.50 off when you buy two). Entering all of the optimization data at step 402 may not be required, particularly if some of the optimization data is optional, unnecessary, or already exists in the database 314. For example, if no coupon information is available or if no coupons exist for the desired and/or companion products, the coupon information does not need to be entered at step 402.

In one embodiment, a user may manually input the optimization data into the database 314 in order to begin optimization of the purchase of the desired product. The optimization data may be entered into the desired product optimization application 318 through the screen display 204 on the computer 102. In another embodiment, the optimization data can be obtained by accessing a pricing database 110 through the retail server computer 104. The pricing database 110 may include some or all of the optimization data needed to execute the desired product optimization application 318. The retail server computer 104 and the database 110 may be operated by the retail store where the products are sold or may be a publicly available information resource. In a further embodiment, the input portion 214 of the computer 102 may be used to obtain the optimization data in conjunction with the bar code scanning application 320 and the database 110. As discussed above, the input portion 214 may include a barcode scanner or camera that can obtain the information encoded in a UPC barcode on the packaging of a product. The UPC barcode can be used to lookup some or all of the optimization data for the associated product in the database 110. Once the UPC barcode is obtained by the input portion 214, the bar code scanning application 320 may process the UPC and access the database 110 to retrieve the associated optimization data for the product.

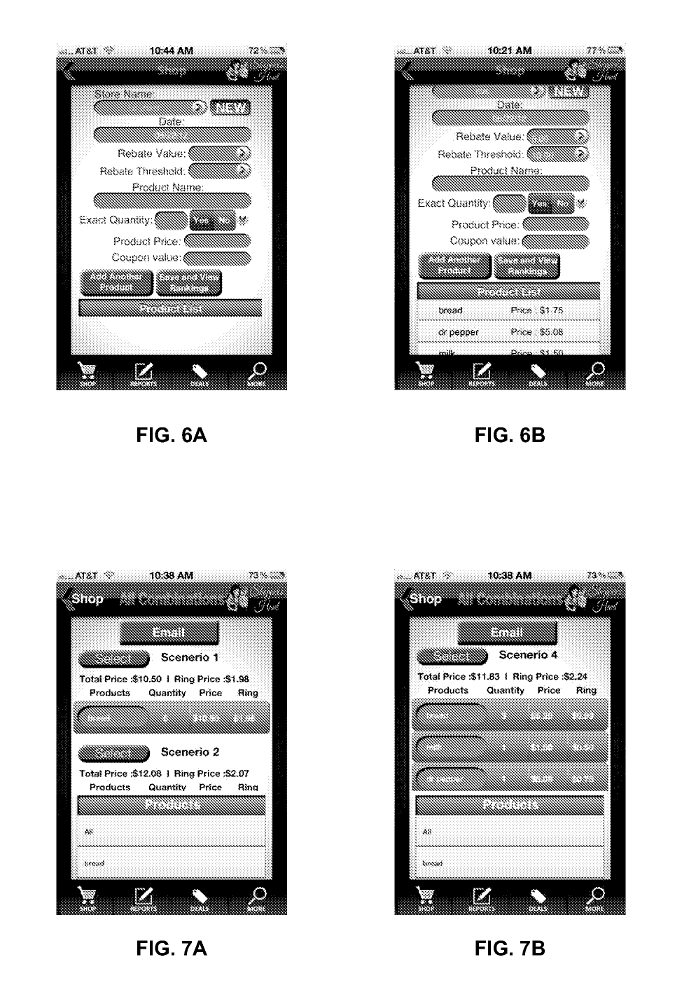

Exemplary screenshots of a mobile application including an interface screen for entering the optimization data are shown in FIGS. 6A and 6B. The interface screens in FIGS. 6A and 6B include fields for entering a store name, the date, a rebate amount or value, a rebate threshold or price threshold, a product name, an exact quantity, a product price or shelf price, and a coupon value. The interface screen further includes the ability to add multiple products, as seen in the Product List of FIG. 6B that shows a list of already-entered products and their respective prices.

Following input of the optimization data at step 402, the desired product optimization application 318 generates product selection interface screens at step 404 that allow the user to interact with a product list that includes desired and companion products. The product selection interface screens are displayed on the screen display 204 of the computer 102. One or more products may be displayed on the product selection interface screens and may be categorized and ordered by product name, category, brand name, shelf price, ring price, or other characteristics. In one embodiment, the products may be hierarchically organized in multiple ways by their characteristics or other criteria. For example, Swiss Miss brand hot cocoa may be categorized under Beverages, then Non-Carbonated. The Swiss Miss brand hot cocoa may also be alphabetically categorized by its brand name, such as under S. The user can select one or more desired products from the product selection interface screens. The user's selection is received by the desired product optimization application 318 at step 406. The user may also enter a quantity of the desired product that he or she wishes to purchase and the quantity will be used by the desired product optimization application 318. As discussed above, a desired product is a product that the user intends to purchase for personal or business use. The products that are not selected are considered companion products, i.e., products that the user does not necessarily intend to purchase for personal or business use. The user may purchase companion product(s) to take advantage of a sale or rebate associated with the companion product that will allow the user to purchase the desired product at a price lower than the shelf price or ring price of the desired product.

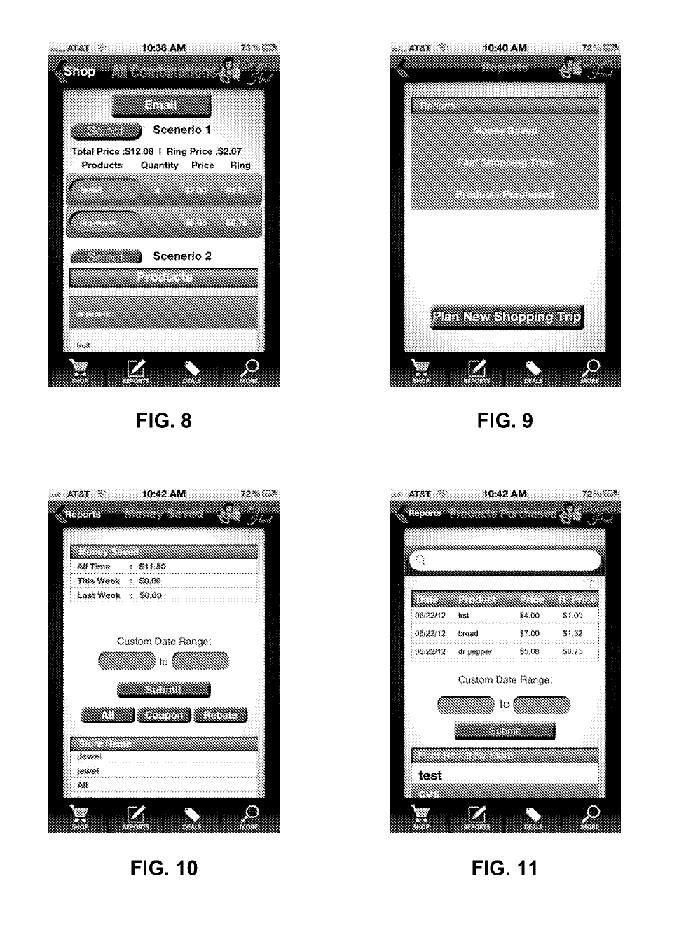

In some embodiments, selection of the desired product and/or companion product at steps 404 and 406 may occur as part of or after step 410 related to transmitting results. FIG. 8 shows an exemplary screenshot of a mobile application including a results screen that includes the ability for a user to select a desired product. As shown in FIGS. 7A and 7B, one or more initial results with combinations of desired and/or companion products may be shown to the user. In FIG. 8, the user has selected a desired product, e.g., Dr. Pepper, and the results can be filtered so that only results with the desired product are shown. When filtered, the results may include the desired product and/or companion product(s). Computation of the results is described in more detail below.

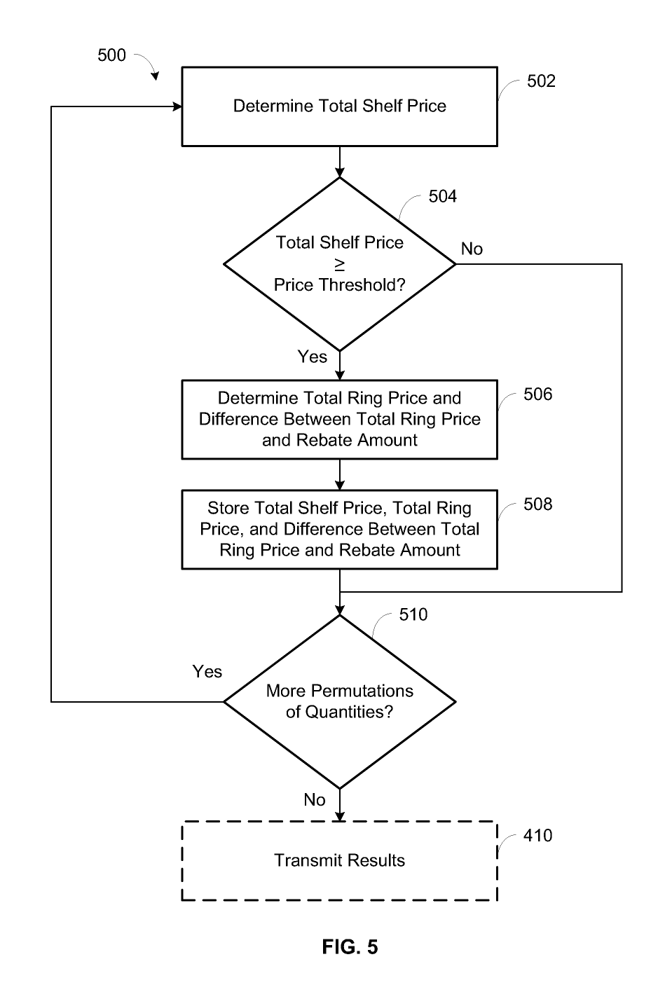

The desired product optimization application 318 optimizes the purchase of the desired product and/or companion products at step 408. Details of the optimization performed by the desired product optimization application 318 are discussed below in reference to the flow chart 500 illustrated in FIG. 5. The results from the desired product optimization application 318 at step 408 are transmitted at step 410 and may include quantity and product information for the desired and companion products that the user may purchase in order to maximize savings and optimally reduce out-of-pocket expenses. For example, the exemplary screenshots of FIGS. 7A and 7B show multiple scenarios that include total prices, ring prices, quantities, and products. As detailed above, the results may preferably be displayed in order of lowest to highest total ring price such that the user is informed of the greatest value, i.e., the least amount that can be spent out-of-pocket on the desired and/or companion products in order to obtain the desired product, as shown in FIGS. 7A and 7B. The results may also be adjusted at step 410 to account for any coupon information that was entered into the desired product optimization application 318 at step 400. For example, the total ring prices may be reduced by one or more coupons that are applicable to the desired and/or companion products.

FIG. 5 is a flow chart 500 illustrating a process or method for determining the optimization of the purchase of the desired product. The flow chart 500 corresponds to step 408 of the flow chart 400 in FIG. 4. At step 502, the total shelf price is determined based on the shelf prices of the selected desired product and one or more companion products. The total shelf price may be based on a quantity selected by the user at step 406 or may be determined by the desired product optimization application 318. In one embodiment, the desired product optimization application 318 optimizes the purchase of the desired product by analyzing a range of quantities, where each quantity is multiplied by the shelf prices of the desired product and one or more companion products. The range of quantities may be zero or non-zero. Regardless of whether the quantity is supplied by the user or by the desired product optimization application 318, the total shelf price determined at step 502 is equal to the shelf price for one unit of the product (desired or companion) multiplied by the quantity. The total shelf price is compared to the price threshold at step 504. The analysis may proceed using a brute-force method, for example, where permutations of quantities multiplied by the respective shelf prices are calculated and compared to the price threshold at steps 502, 504, and 510.

If the total shelf price is greater than or equal to the price threshold at step 504, the desired product optimization application 318 continues to step 506. If the total shelf price is less than the price threshold at step 504, the desired product optimization application 318 continues to step 510. When the total shelf price is greater than or equal to the price threshold, the total ring price is determined at step 506 based on the ring prices of the selected desired product and the companion products. The total ring price determined at step 506 is equal to the ring price for one unit of the product (desired or companion) multiplied by the quantity. The difference between the total ring price and the rebate amount is also calculated at step 506. Continuing to step 508, the total ring price, the total shelf price, and the difference between the total ring price and the rebate amount are stored in the memory 312 for use by the desired product optimization application 318 when transmitting the optimization results at step 410. At step 510, if there are more permutations of quantities left to be tried, the process returns to step 502 to calculate another total shelf price of desired and companion products using a different combination of quantities. In one embodiment, the permutations of quantities tried by the desired product optimization application 318 are not limited by the quantity of combinations that make the calculated total shelf price equal to or just greater than the price threshold. However, in another embodiment, the desired product optimization application 318 does not try all possible quantity combinations, but instead stops once it is determined that the total shelf prices equal to or just greater than the price threshold have been found. The permutations of quantities that are tried may also or instead be capped at a specific threshold number of permutations, in some embodiments. If there are no more permutations of quantities left to be tried at step 510, then the results of the desired product optimization application 318 are transmitted at step 410, as discussed above.

Exemplary screenshots of one embodiment of the desired product optimization application 318 displayed on a mobile application interface including the transmitted results are shown in FIGS. 7A and 7B. The results may include multiple scenarios that include total prices, ring prices, quantities, and products. Some or all of the results may be emailed from the mobile application interface or saved to the memory 212 or other memory for generating analysis reports. As described above, the results may be ordered in order of ring price, in one embodiment.

Exemplary screenshots of a mobile application including analysis reports are shown in FIGS. 9, 10, and 11. In particular, FIG. 9 shows an exemplary screenshot of an interface for generating analysis reports. The analysis reports may include data from optimization data that was entered previously and/or the results of calculations related to optimizing the purchase of products. For example, the analysis reports may include information and analysis regarding money saved through use of the mobile application (as shown in FIG. 10), history of past shopping trips, and products purchased (as shown in FIG. 11). The analysis reports may be filtered and/or customized by date, product names, stores, and other parameters. The mobile application may further include news, links, current deals, expired deals, and/or other information.

To further illustrate the present invention, exemplary executions of the desired product optimization application 318 with desired and companion product information, shelf prices, ring prices, a price threshold, and a rebate amount are described as follows.

In the first example, the price threshold to receive a rebate is $10.00 and the rebate amount is $5.00. There are three products available for purchase: Product A, Product B and Product C. The shelf price for one unit of Product A is $2.99 and the ring price for one unit of Product A is $1.99. The shelf price for one unit of Product B is $4.50 and the ring price for one unit of Product B is $4.00. The shelf price for one unit of Product C is $4.99 and the ring price for one unit of Product C is $2.00. The optimization data (product information, shelf prices, ring prices, price threshold, and rebate amount) is entered into the desired product optimization application 318 at step 402.

The user may select Product A as the desired product using the product selection interface screens generated by the desired product optimization application 318, at steps 404 and 406. The desired product optimization application 318 may then optimize the purchase of the desired Product A at step 408 and the corresponding flow chart 500. Table 1 below shows the permutation of quantities for each of the products and the resulting total shelf prices and total ring prices that occur during steps 502, 504, 506, 508 and 510. As discussed above, the total shelf price, the total ring price, and the difference between the total ring price and the rebate amount are only stored if the total shelf price for a particular quantity permutation is greater than or equal to the price threshold of $10.00. In the tables below, SP stands for shelf price, RP stands for ring price, and TRP stands for total ring price.

TABLE 1
Permutation of Quantities, Total Shelf Price and
Total Ring Price (Example 1)

| Product A | Product B | Product C | | | Difference |
|---|---|---|---|---|---|
| SP: $2.99 | SP: $4.50 | SP: $4.99 | Total | Total | Between TRP |
| RP: $1.99 | RP: $4.00 | RP: $2.00 | Shelf | Ring | and Rebate |
| Quantity | Quantity | Quantity | Price | Price | Amount ($5.00) |
| 4 | 0 | 0 | $11.96 | $7.96 | $2.96 |
| 3 | 1 | 0 | $13.47 | $9.97 | $4.97 |
| 3 | 0 | 1 | $13.96 | $7.97 | $2.97 |
| 2 | 1 | 0 | $10.48 | $7.98 | $2.98 |
| 2 | 0 | 1 | $10.97 | $5.98 | $0.98 |
| 1 | 2 | 0 | $11.99 | $9.99 | $4.99 |
| 1 | 1 | 1 | $12.48 | $7.99 | $2.99 |
| 1 | 0 | 2 | $12.97 | $5.99 | $0.99 |
| 0 | 3 | 0 | $13.50 | $12.00 | $7.00 |
| 0 | 2 | 1 | $13.99 | $10.00 | $5.00 |
| 0 | 1 | 2 | $14.48 | $8.00 | $3.00 |
| 0 | 0 | 3 | $14.97 | $6.00 | $1.00 |

Following the optimization process of step 408 and the corresponding flow chart 500, the results are transmitted at step 410. As discussed above, the results from the desired product optimization application 318 may be ranked in order of the difference between the total ring price and the rebate amount so that the user can minimize their out-of-pocket expense while still obtaining the desired product. Table 2 below shows the results ranked in order of the smallest to largest difference between the total ring price and the rebate amount.

TABLE 2
Ranked Results (Example 1)

| Product A | Product B | Product C | | | Difference |
|---|---|---|---|---|---|
| SP: $2.99 | SP: $4.50 | SP: $4.99 | Total | Total | Between TRP |
| RP: $1.99 | RP: $4.00 | RP: $2.00 | Shelf | Ring | and Rebate |
| Quantity | Quantity | Quantity | Price | Price | Amount ($5.00) |
| 2 | 0 | 1 | $10.97 | $5.98 | $0.98 |
| 1 | 0 | 2 | $12.97 | $5.99 | $0.99 |
| 0 | 0 | 3 | $14.97 | $6.00 | $1.00 |
| 4 | 0 | 0 | $11.96 | $7.96 | $2.96 |
| 3 | 0 | 1 | $13.96 | $7.97 | $2.97 |
| 2 | 1 | 0 | $10.48 | $7.98 | $2.98 |
| 1 | 1 | 1 | $12.48 | $7.99 | $2.99 |
| 0 | 1 | 2 | $14.48 | $8.00 | $3.00 |
| 3 | 1 | 0 | $13.47 | $9.97 | $4.97 |
| 1 | 2 | 0 | $11.99 | $9.99 | $4.99 |
| 0 | 2 | 1 | $13.99 | $10.00 | $5.00 |
| 0 | 3 | 0 | $13.50 | $12.00 | $7.00 |

One, some, or all of the ranked results may be transmitted to the user at step 410. In this first example, the user selected Product A as the desired product that the user wished to purchase for personal or business use. The greatest value for the user is purchasing two units of Product A and one unit of Product C, resulting in an out-of-pocket expense of $0.98. Specifically, the initial out-of-pocket expense for the user is the total ring price of $5.98 but following the receipt of the rebate amount of $5.00, the net out-of-pocket expense is $0.98. However, if a particular product is out of stock, the user can utilize the results to purchase another combination of desired and companion products. Therefore, if Product C is out of stock, the user can instead purchase four units of Product A for an initial out-of-pocket expense of $7.96 and a net out-of-pocket expense of $2.96 following receipt of the rebate amount of $5.00. While the net out-of-pocket expense in this case is not as optimal as the $0.98 net out-of-pocket expense when purchasing two units of Product A and one unit of Product C, the user would still be able to take advantage of the products' ring prices and the rebate. In this first example, the desired and companion products may be purchased in a single transaction.

For the second example, the price threshold to receive a rebate is $9.00 and the rebate amount is $6.00. In this example, the desired and companion products may be purchased in one transaction or in multiple transactions. There are three products available for purchase: Product D, Product E, and Product F. The shelf price for one unit of Product D is $3.00 and the ring price for one unit of Product D is $2.19. The shelf price for one unit of Product E is $5.00 and it is not on sale, so the ring price for one unit of Product E is also $5.00. The shelf price for one unit of Product F is $4.79 and the ring price for one unit of Product F is $3.99. The user may select Product E as the desired product using the product selection interface screens. The desired product optimization application 318 may then optimize the purchase of the desired Product E at step 408 and the corresponding flow chart 500. Table 3 below shows the permutation of quantities for each of the products and the resulting total shelf prices and total ring prices.

TABLE 3
Permutation of Quantities, Total Shelf Price
and Total Ring Price (Example 2)

| Product D | Product E | Product F | | | Difference |
|---|---|---|---|---|---|
| SP: $3.00 | SP: $5.00 | SP: $4.79 | Total | Total | Between TRP |
| RP: $2.19 | RP: $5.00 | RP: $3.99 | Shelf | Ring | and Rebate |
| Quantity | Quantity | Quantity | Price | Price | Amount ($6.00) |
| 3 | 0 | 0 | $9.00 | $6.57 | $0.57 |
| 2 | 1 | 0 | $11.00 | $9.38 | $3.38 |
| 2 | 0 | 1 | $10.79 | $8.37 | $2.37 |
| 1 | 1 | 1 | $12.79 | $11.18 | $5.18 |
| 1 | 0 | 2 | $12.58 | $10.17 | $4.17 |
| 0 | 1 | 1 | $9.79 | $8.99 | $2.99 |
| 0 | 0 | 2 | $9.58 | $7.98 | $1.98 |
| 0 | 2 | 0 | $10.00 | $10.00 | $4.00 |

Following the optimization process of step 408 and the corresponding flow chart 500, the results are transmitted at step 410. The results from the desired product optimization application 318 may be ranked in order of the difference between the total ring price and the rebate amount so that the user can minimize their out-of-pocket expense while still obtaining the desired product. Table 4 below shows the results ranked in order of the smallest to largest difference between the total ring price and the rebate amount for this second example.

TABLE 4
Ranked Results (Example 2)

| Product D | Product E | Product F | | | Difference |
|---|---|---|---|---|---|
| SP: $3.00 | SP: $5.00 | SP: $4.79 | Total | Total | Between TRP |
| RP: $2.19 | RP: $5.00 | RP: $3.99 | Shelf | Ring | and Rebate |
| Quantity | Quantity | Quantity | Price | Price | Amount ($6.00) |
| 3 | 0 | 0 | $9.00 | $6.57 | $0.57 |
| 0 | 0 | 2 | $9.58 | $7.98 | $1.98 |
| 2 | 0 | 1 | $10.79 | $8.37 | $2.37 |
| 0 | 1 | 1 | $9.79 | $8.99 | $2.99 |
| 2 | 1 | 0 | $11.00 | $9.38 | $3.38 |
| 0 | 2 | 0 | $10.00 | $10.00 | $4.00 |
| 1 | 0 | 2 | $12.58 | $10.17 | $4.17 |
| 1 | 1 | 1 | $12.79 | $11.18 | $5.18 |

In this second example, the user selected Product E as the desired product that the user wished to purchase for personal or business use. The greatest value for the user is purchasing three units of Product D, resulting in a net out-of-pocket expense of $0.57. In particular, the out-of-pocket expense for the user is the total ring price of $6.57 in the first transaction but following the receipt of the rebate amount of $6.00, the net out-of-pocket expense is $0.57. In this case, the user can utilize the rebate amount of $6.00 to purchase at least one unit of Product E in a second transaction since the ring price of Product E is $5.00. If the user wishes, he or she could repeat the first transaction of purchasing three units of Product D five times (for a total of 15 units of Product D purchased) in order to get five $6.00 rebates for a total of $30 in rebates. The $30 in rebates could then be used to purchase six units of the desired Product E in a future transaction.

In another scenario using this second example, if Product D is out of stock, the user could instead purchase two units of Product F, resulting in a net out-of-pocket expense of $1.98. Similar to the previous scenario, the out-of-pocket expense for the user in the first transaction is the total ring price of $7.98 but because the rebate amount is $6.00, the net out-of-pocket expense becomes $1.98. Again, the user can utilize the rebate amount of $6.00 to purchase at least one unit of Product E in a second transaction. As before, the user could repeat the first transaction multiple times to receive multiple rebates.

Finally, in a further scenario using this second example, if the user wishes to purchase the desired Product E and the companion products in a single transaction, the user could purchase one unit of Product E and one unit of Product F, resulting in a net out-of-pocket expense of $2.99. While this out-of-pocket expense would not provide the optimal savings, performing a single transaction may be more efficient and save time for the user and the store while still allowing the user to obtain the desired Product E.

Any process descriptions or blocks in figures, such as FIGS. 4 and 5, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method for optimizing a purchase of a desired product using a computer connected to a processor and a user interface, the method comprising:
receiving product information at the processor, the product information comprising the desired product, a companion product, a desired product shelf price, a desired product ring price, a companion product shelf price, a companion product ring price, a price threshold, and a rebate amount;
calculating a total shelf price based on the desired product shelf price and the companion product shelf price, using the processor;
determining, using the processor, whether the total shelf price is greater than or equal to the price threshold;
if the total shelf price is greater than or equal to the price threshold, calculating a total ring price and a difference between the total ring price and the rebate amount, using the processor, based on the desired product ring price, the companion product ring price, and the rebate amount; and
transmitting a result set from the processor to the user interface comprising the total shelf price and the total ring price.

2. The method of claim 1, wherein:
calculating the total shelf price comprises:
multiplying a desired product quantity and the desired product shelf price to produce a total desired product shelf price, using the processor;
multiplying a companion product quantity and the companion product shelf price to produce a total companion product shelf price, using the processor; and
adding the total desired product shelf price and the total companion product shelf price to produce the total shelf price, using the processor; and
calculating the total ring price comprises:
multiplying the desired product quantity and the desired product ring price to produce a total desired product ring price, using the processor;
multiplying the companion product quantity and the companion product ring price to produce a total companion product ring price, using the processor; and
adding the total desired product ring price and the total companion product ring price to produce the total ring price, using the processor.

3. The method of claim 2, further comprising iterating through the steps of calculating the total shelf price, determining whether the total shelf price is greater than or equal to the price threshold, and calculating the total ring price and the difference for a plurality of permutations of the desired product quantity and the companion product quantity, using the processor.

4. The method of claim 3, wherein iterating is performed until the calculated total shelf price just exceeds the price threshold for each of the plurality of permutations of the desired product quantity and the companion product quantity.

5. (canceled)

6. (canceled)

7. (canceled)

8. The method of claim 1, wherein the price threshold comprises one or more of a desired product quantity or a companion product quantity.

9. The method of claim 1, wherein transmitting the result set comprises ordering the result set based on the total ring price, using the processor.

10. The method of claim 1, wherein receiving the product information comprises receiving the desired product, the companion product, the desired product shelf price, the desired product ring price, the companion product shelf price, and the companion product ring price from a pricing database in communication with the processor.

11. (canceled)

12. The method of claim 1, wherein receiving the product information comprises:
receiving a universal product code of the desired product and the companion product from a barcode scanner at the processor; and
retrieving the desired product, the companion product, the desired product shelf price, the desired product ring price, the companion product shelf price, and the companion product ring price based on the universal product code.

13. (canceled)

14. The method of claim 1, further comprising adjusting the total ring price based on one or more of a manufacturer coupon or a store coupon, if the total shelf price is greater than or equal to the price threshold, using the processor.

15. The method of claim 1, wherein the result set further comprises a combination of products, the combination of products comprising one or more of each of the desired product and the companion product.

16. (canceled)

17. (canceled)

18. A computer for optimizing a purchase of a desired product, the computer comprising a processor and a memory comprising a desired product optimization application and a database, the processor in communication with a user interface, the desired product optimization application executable by the processor and configured to:
receive product information for storage in the database, the product information comprising the desired product, a companion product, a desired product shelf price, a desired product ring price, a companion product shelf price, a companion product ring price, a price threshold, and a rebate amount;
calculate a total shelf price based on the desired product shelf price and the companion product shelf price;
determine whether the total shelf price is greater than or equal to the price threshold;
if the total shelf price is greater than or equal to the price threshold, calculate a total ring price and a difference between the total ring price and the rebate amount, based on the desired product ring price, the companion product ring price, and the rebate amount; and
transmit a result set to the user interface comprising the total shelf price and the total ring price.

19. The computer of claim 18, wherein the desired product optimization application is configured to calculate the total shelf price by:
multiplying a desired product quantity and the desired product shelf price to produce a total desired product shelf price;
multiplying a companion product quantity and the companion product shelf price to produce a total companion product shelf price; and
adding the total desired product shelf price and the total companion product shelf price to produce the total shelf price; and
the desired product optimization application is configured to calculate the total ring price by:
multiplying the desired product quantity and the desired product ring price to produce a total desired product ring price;
multiplying the companion product quantity and the companion product ring price to produce a total companion product ring price; and
adding the total desired product ring price and the total companion product ring price to produce the total ring price.

20. The computer of claim 19, wherein the desired product optimization application is further configured to iterate through the steps of calculating the total shelf price, determining whether the total shelf price is greater than or equal to the price threshold, and calculating the total ring price and the difference for a plurality of permutations of the desired product quantity and the companion product quantity.

21. The computer of claim 20, wherein the desired product optimization application is configured to iterate until the calculated total shelf price just exceeds the price threshold for each of the plurality of permutations of the desired product quantity and the companion product quantity.

22. (canceled)

23. (canceled)

24. (canceled)

25. The computer of claim 18, wherein the price threshold comprises one or more of a desired product quantity or a companion product quantity.

26. The computer of claim 18, wherein the desired product optimization application is configured to transmit the result set by ordering the result set based on the total ring price.

27. The computer of claim 18, wherein the desired product optimization application is configured to receive the product information by receiving the desired product, the companion product, the desired product shelf price, the desired product ring price, the companion product shelf price, and the companion product ring price from a pricing database in communication with the processor.

28. (canceled)

29. The computer of claim 18, further comprising a barcode scanner, and wherein the desired product optimization application is configured to receive the product information by:
receiving a universal product code of the desired product and the companion product from the barcode scanner; and
retrieving the desired product, the companion product, the desired product shelf price, the desired product ring price, the companion product shelf price, and the companion product ring price based on the universal product code.

30. (canceled)

31. The computer of claim 18, the desired product optimization application is further configured to adjust the total ring price based on one or more of a manufacturer coupon or a store coupon, if the total shelf price is greater than or equal to the price threshold.

32. The computer of claim 18, wherein the result set further comprises a combination of products, the combination of products comprising one or more of each of the desired product and the companion product.

33. (canceled)

34. (canceled)
